(19) United States
(12) Patent Application Publication
(10) Pub. No.: US 2016/0205251 A1
(43) Pub. Date: Jul. 14, 2016

(54) System and Method for Quality Monitoring and Agent Suitability in Video Communication Processed in Contact Center

(71) Applicant: Avaya Inc., Santa Clara, CA (US)

(72) Inventors: Liam LOFTUS, Knocknacarra (IE); Padraig MEANEY, Doughiska (IE); Philip MCCANN, Athenry (IE); Michael MCBRIDE, Lower Salthill (IE)

(21) Appl. No.: 14/596,629

(22) Filed: Jan. 14, 2015

(51) Int. Cl. H04M 3/51

(52) U.S. Cl. CPC H04M 3/5175; H04M 3/5183

(57) ABSTRACT

A method and system automatically monitors quality and agent suitability in a video communication processed at a contact center. The method performed by a monitoring device includes receiving a plurality of consecutive images of a video communication between an agent device used by an agent of a contact center and a user device used by a user with a request. The method includes determining at least one agent action performed during the video communication that is outside a predetermined parameter. The method includes determining a change that the agent is to perform based upon the agent action. The method includes transmitting the change to the agent device.

### BACKGROUND INFORMATION

A contact center may be used by a provider to enable a user to submit a query or request for an issue or a service handled by the provider. Specifically, an agent may be employed at the contact center who receives a ticket associated with the query/request such as via an email, a voice communication, etc. The ticket may include all relevant information for the agent to properly generate a response for the user. The agent may utilize any available resource to determine the correct response for the ticket. For example, the agent may rely upon proprietary tools, publicly available information, privacy information corresponding to the user, etc.

The contact center also enables real-time communications between the user and an agent of the contact center. For example, the user may use the voice communication. In another example, the user may use a chat communication. However, an increasingly more available format to submit and resolve a request in real-time between the user and the agent of the contact center involves the use of a video communication such as Web Real Time Communication (WebRTC). In the video communication, a real-time video call mechanism enables the user to view the agent and vice versa while discussing the request.

Those skilled in the art will understand that the video communication poses many additional challenges beyond those experienced with non-visual communications. For example, objects in a workspace of the agent may be shown within a visual area of the video communication, thereby being visible to the user. In another example, the agent must maintain a professional demeanor not only in a vocal manner but in expressions and movements that the user may also view. Thus, to ensure quality assurance during the video communication, the agent may be required to have an appropriate appearance as well as maintain a visual area of the workspace within acceptable parameters.

Conventional approaches in meeting these standards include using tools to provide necessary recordings for a supervisor to expend significant effort in reviewing the screen recordings to assess the quality of the agents' appearance. In another approach, a supervisor may manually perform a visual inspection of the agents such as prior to participating in video communications. For voice media, analytic tools are available to report the use of keywords or terms over the course of the call while text based media (e.g., chat) may utilize keyword spotting. However, the conventional approaches only provide for a statistical sampling to determine a sample set of video communications that need to be reviewed. While the audio component may be analyzed in an automated manner, the non-verbal communications of the video communication cannot be sampled in such an automated manner. Therefore, this may often lead to missing an offense prior to participating in video communications or being too late when an already occurred recorded video communication is being reviewed.

Thus, there is a need for a system to analyze in an automated manner the visual aspects of a video communication both prior to participation and during participation.

### BRIEF DESCRIPTION OF THE DRAWINGS

FIG. 1 shows an exemplary contact center system.

FIG. 2 shows an exemplary agent device of the contact center system of FIG. 1.

FIG. 3 shows an exemplary supervisor device of the contact center system of FIG. 1.

FIG. 4 shows an exemplary oversight device of the contact center system of FIG. 1.

FIG. 5 shows an exemplary method for determining visual components of a visual area in a video communication.

FIG. 6 shows an exemplary method for determining agent actions during a video communication.

FIG. 7 shows an image of a visual area in a video communication.

### DETAILED DESCRIPTION

The exemplary embodiments may be further understood with reference to the following description and the related appended drawings, wherein like elements are provided with the same reference numerals. The exemplary embodiments are related to a system and method for quality monitoring and agent suitability in a video communication processed at a contact center. Specifically, the exemplary embodiments provide a first automated mechanism to determine whether a visual area that is visible to a user during a video communication is within acceptable parameters of the contact center. The exemplary embodiments further provide a second automated mechanism to determine whether an agent's actions during a video communication are within acceptable parameters or require changes or review by a supervisor. The contact center, the supervisor, the agent, video communication with a user, the visual area, the agent actions, and related methods will be described in further detail below.

Initially, it should be noted that the exemplary embodiments described herein relate to a contact center that receives queries or requests (herein collectively referred to as “requests”). However, those skilled in the art will understand that the exemplary embodiments may be applied to any system in which an agent communicates over a video communication with a user having the request. Thus, the contact center used herein may represent any of these systems. It should also be noted that the use of the agent and the user is only exemplary. Those skilled in the art will also understand that the exemplary embodiments may be applied to any first user who represents a first party to the video communication with any second user who represents at least one second party to the video communication. It should further be noted that the use of video communication is only exemplary. Those skilled in the art will understand that the exemplary embodiments may relate to any communication, particularly one in real-time, where the first user and the second user may view one another during the communication.

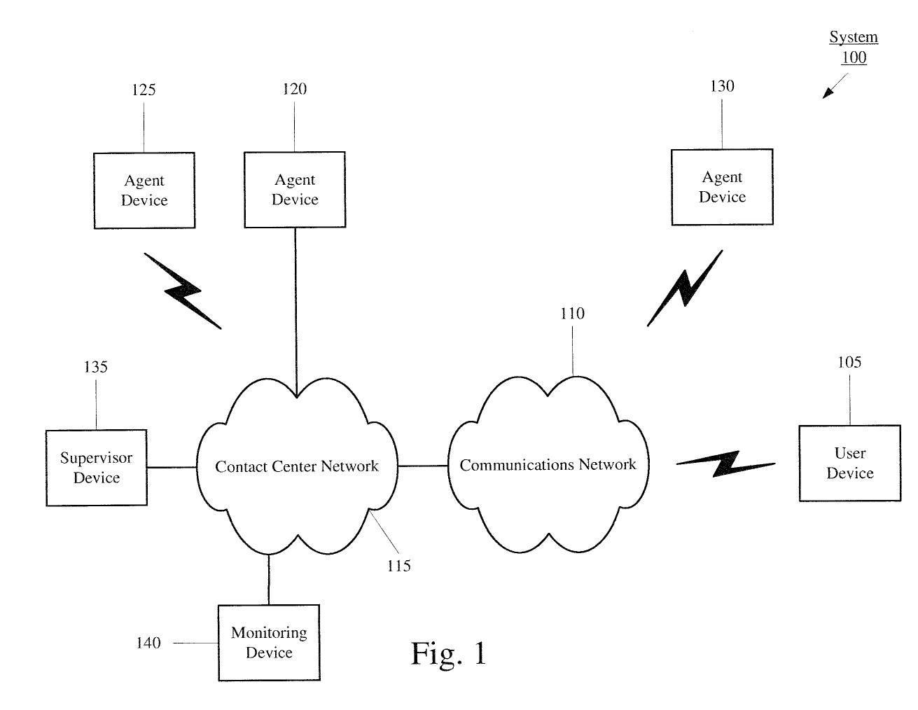

FIG. 1 shows an exemplary system 100 including a contact center and a means for a user to communicate with the contact center. The system 100 may include a communications network 110 and a contact center network 115 which are communicatively connected to one another. Accordingly, end devices connected to the communications network 110 and/or the contact center network 115 may communicate with each other. The system 100 may enable a user device 105 utilized by a user to transmit a request via the communications network 110 and the contact center network 115 to an agent device 120 utilized by an agent so that a video communication may be established therebetween for the request to be discussed. As will be described in further detail below, the system 100 may further include a supervisor device 135 and a monitoring device 140.

The user device 105 may represent an electronic device in which a user may transmit a request to the contact center network 115. Specifically, the request and its resolution may be performed over a video communication. For example, the user device 105 may be any electronic component that is configured to communicate via the communications network 110 using the video communication such as a desktop computer, a laptop, a smartphone, etc. The user device 105 is shown as wirelessly communicating with the communications network 110. However, it should be noted that the user device 105 may also connect to the communications network 110 using other means such as a wired connection. Accordingly, the user device 105 may include corresponding components to enter the request (e.g., an input/output (I/O) device), to connect to the communications network 110 (e.g., a transceiver), to transmit the request, to perform the video communication (e.g., an imager), etc.

The communications network 110 may represent any single or plurality of networks used by the user device 105 to communicate with the contact center via the contact center network 115. For example, if the user device 105 is a personal home computer, the communications network 110 may include a home network in which the user device 105 may initially connect. The home network may connect to a network of an Internet service provider to connect to the Internet. Subsequently, through the Internet, a connection may be established with the contact center network 115. It should be noted that the communications network 110 and all networks that may be included therein may be any type of network such as a Local Area Network (LAN), a Wide Area Network (WAN), Virtual LAN (V-LAN), etc. using any variety of radio access networks such as 3G, 4G, Long Term Evolution (LTE), WiFi, etc.

The contact center network 115 may enable a plurality of devices to be interconnected with one another. For example, the contact center network 115 may be a proprietary network accessible in one manner by the agent devices 120-130, the supervisor device 135, and the monitoring device 140. Specifically, the agent devices 120-130, the supervisor device 135, and the oversight device 140 may be connected to the contact center network 115 via an authorized or privileged connection for select information and data to be accessed. However, as discussed above, the contact center network 115 may be accessed in another manner via the communications network 110 by the user device 105. This connection may enable communications to be transmitted and/or received between the end devices without access to the above noted information and data, particularly using the video communication.

The contact center network 115 may also enable direct connections thereto using, for example, both wired and wireless connections. Specifically, the agent device 120 may utilize a wired connection to establish the connection with the contact center network 115. The agent device 125 may utilize a wireless connection to establish the connection with the contact center network 115. Furthermore, the agent device 120 and the agent device 125 may be within a predetermined proximity of the contact center network 115 in order to establish the connection. Using an authorization procedure (e.g., login and password), the connection for the agent devices 120, 125 may be established. In addition, the contact center network 115 may enable remote connections thereto using, for example, the communications network 110. For example, an agent may work remotely from a location that is outside the proximity of the contact center network 115 such as the agent device 130. Using authentication, authorization, and accounting (AAA) procedures (via a AAA server), the agent device 130 may establish a connection with the contact center network 115 in a substantially similar manner as the agent devices 120, 125.

In view of the above description of the contact center network 115, it should be noted that the contact center network 115 may include a variety of components (not shown) to enable these functionalities. For example, the contact center network may include a server, a router, a switch center, a network management arrangement, a database, etc. It should also be noted that the use of three agent devices 120-130 is only exemplary. Those skilled in the art will understand that the contact center may utilize any number of agent devices. It should further be noted that the use of one supervisor device 135 is only exemplary. Those skilled in the art will understand that the contact center may utilize any number of supervisor devices to manage one or more agent devices.

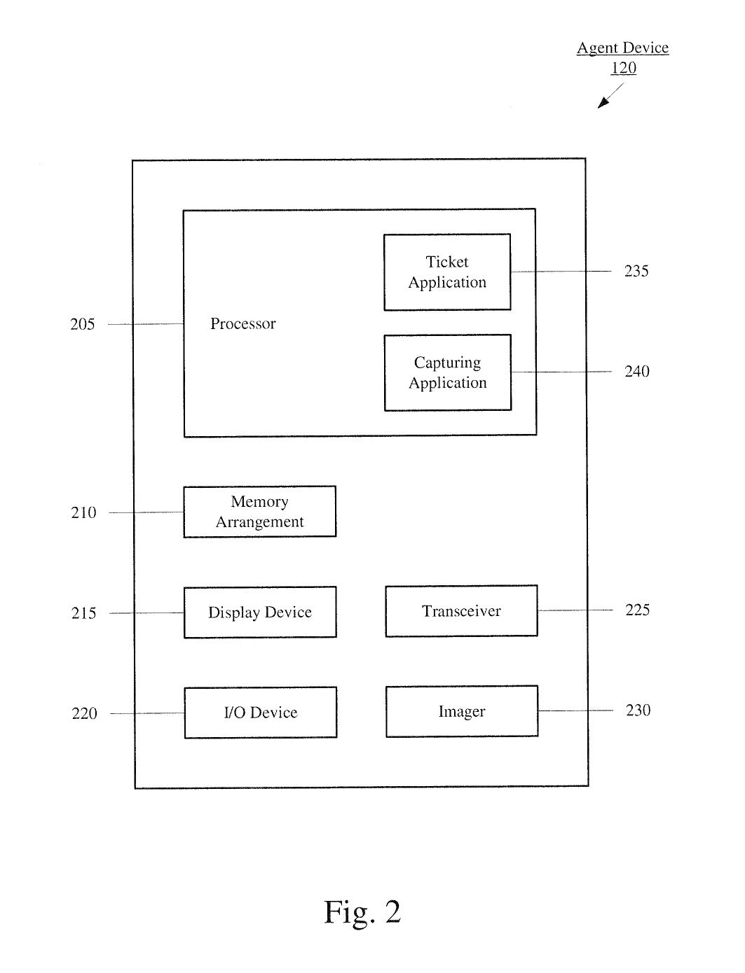

FIG. 2 shows the exemplary agent device 120 of the contact center system 100 of FIG. 1. As discussed above, the agent device 120 may be utilized by an agent to receive a request from a user via the user device 105 and to perform a video communication therewith. The agent may subsequently use a process to determine a response or resolution for the request during the video communication. The description herein for the agent device 120 may be representative of the agent devices 125, 130 as well. The agent device 120 may also represent any electronic device that is configured to perform the functionalities described herein. For example, the agent device 120 may be a portable device such as a tablet, a laptop, etc. In another example, the agent device 120 may be a client stationary device such as a desktop terminal. The agent device 120 may include a processor 205, a memory arrangement 210, a display device 215, an I/O Device 220, a transceiver 225, an imager 230, and other components (e.g., an audio input device (for use during the video communication relating to the voice input component), an audio output device (for use during the video communication relating to the voice output component), a battery, a data acquisition device, ports to electrically connect the agent device 120 to other electronic devices, etc.).

The processor 205 may be configured to execute a plurality of applications of the agent device 120. For example, the applications may include a web browser when connected to the contact center network 115 and also the communications network 110 the transceiver 225. In another example, the processor 205 may execute a ticket application 235. The ticket application 235 may include a plurality of tools and receive other information determined from other applications such as the web browser. The ticket application 235 may also perform the video communication functionality. That is, among the tools provided thereby, the ticket application 235 may have a request from the user forwarded to the agent device 120 (e.g., through a switch component of the contact center network 115) and establish the video communication session between the agent and the user. In a further example, the processor 205 may execute a capturing application 240. The capturing application 240 may operate in conjunction with the ticket application 235. Specifically, the capturing application 240 may utilize the imager 230 to capture images of the agent to be used for the video communication. The capturing application 240 may continuously capture the images through the imager 230 to generate the video component of the video communication. As will be described in further detail below, the capturing application 240 may also be configured to generate a snapshot or image to be used in evaluating the agent's appearance and/or the visual area of the video communication prior to participating in any video communication.

It should be noted that the above noted applications each being an application (e.g., a program) executed by the processor 205 is only exemplary. The functionality associated with the applications may also be represented as a separate incorporated component of the agent device 120 or may be a modular component coupled to the agent device 120, e.g., an integrated circuit with or without firmware.

The memory 210 may be a hardware component configured to store data related to operations performed by the agent device 120. Specifically, the memory 210 may store data related to the web browser, the ticket application 235, the capturing application 240, etc. For example, the call application may utilize a contact list who may be experts or consultants required to reach during the response process. In another example, the images captured through the imager 230 may be stored for use by the capturing application 240 or for transmission to the monitoring device 140. The display device 215 may be a hardware component configured to show data to a user while the I/O device 220 may be a hardware component that enables the user to enter inputs. It should be noted that the display device 215 and the I/O device 220 may be separate components or integrated together such as a touchscreen.

The transceiver 225 may be a hardware component configured to transmit and/or receive data, particularly related to the video communication. That is, the transceiver 225 may enable the video communication with other electronic devices directly or indirectly through a network based upon an operating frequency of the network. The transceiver 225 may operate on a variety of different frequencies or channels (e.g., set of consecutive frequencies) that are related to the functionalities of the different applications being performed.

As described above, the agent devices 120-130 may execute the ticket application 235. Specifically, the user device 105 may transmit information included in a request such as in the form of a ticket to the contact center. The contact center network 115 may process the ticket and determine an appropriate agent to deliver the ticket to subsequently establish the video communication with the user of the user device 105. Those skilled in the art will understand that the selection of the agent may be performed in a variety of manners. For example, each agent may have qualifications and/or indicators associated with an agent identity. The ticket may be processed to determine any indicators or tags that are included therein. For example, the user device 105 may be prompted to select various fields while completing the ticket. The fields may include these indicators or tags. Therefore, the appropriate agent may be selected to have the request transmitted.

While discussing the request with the user of the user device 105, the agent may perform a response process to determine how to address the request. There are a variety of different ways including a variety of different mechanisms to use in which the response process may be performed as well as in a variety of different contexts based upon a product or service that the contact center is associated. For example, if the contact center relates to determining an insurance quote, the agent may utilize the ticket application 235 that may include a quote calculator that incorporates the information that the user has provided. Those skilled in the art will understand that any number of different tools and information may be used in the response process and that the exemplary embodiments may be applied to each of these different scenarios. For example, as discussed above, the ticket application 235 may include a plurality of tools or the agent may utilize further applications to receive information that may be used in the response process.

While the agent using the agent device 120 is performing the video communication, the capturing application 240 may be configured to transmit images of the agent to the monitoring device 140. The images captured by the imager 230 may be performed in a variety of manners. For example, the images may be captured at predetermined time intervals where each time interval may be determined based upon a probability that a change will occur. In another example, the images may be captured when a significant movement is detected. That is, the imager 230 and the capturing application 240 may further be configured to perform this functionality of detection to trigger a capture of at least one image. In a further example, the images may be captured continuously to provide a full video capture of the video communication.

It should again be noted that the ticket application 235 and the capturing application 240 may be used for any type of product or service that the contact center is associated. The exemplary embodiments may be applied in each of these instances and provide the functionalities described herein without significant modifications thereto. For example, the contact center may be used for any product or service ranging from sales, insurance, customer service, etc. and the exemplary embodiments may be used therewith.

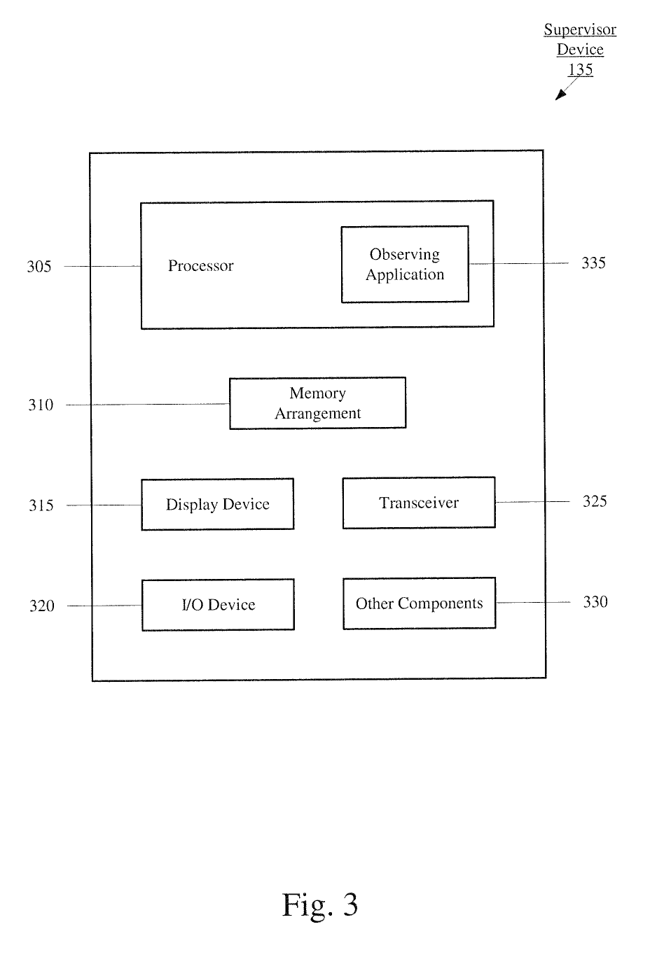

FIG. 3 shows the exemplary supervisor device 135 of the contact center system 100 of FIG. 1. As discussed above, the supervisor device 135 may be utilized by a supervisor who is responsible for a plurality of agents such as those using the agent devices 120-130. Although the exemplary embodiments relate in one manner to an automated operation of determining when the agent's actions or visual area for the video communication are outside acceptable parameters, the exemplary embodiments may further be configured to provide further non-real-time functionalities. For example, the monitoring device 140 may use a statistical sampling of recorded video communications to be provided to the supervisor device 135 for review. In a substantially similar manner as the agent device 120, the supervisor device 135 may represent any electronic device that is configured to perform the functionalities described herein. The supervisor device 135 may also include a processor 305, a memory arrangement 310, a display device 315, an I/O device 320, a transceiver 325 and other components 330. These components may provide functionalities substantially similar to those corresponding to the agent device 120.

With regard to the supervisor device 135, the processor 305 may be configured to execute a plurality of applications of the supervisor device 135. For example, the supervisor device 135 may also execute a web browser and a call application in a substantially similar manner as the agent device 120. However, the supervisor device 135 may execute an observing application 335. The observing application 335 may provide yet another mechanism for agent actions and visual area inspections to be performed. The observing application 335 may enable the supervisor to select an agent device 120-130 that is performing a video communication. The observing application 335 may perform a functionality in which the supervisor device 135 does not participate in the video communication but allows the video communication to be viewed and heard. In this manner, the supervisor may be aware of whether the agent actions and/or visual area is within acceptable parameters or whether changes are to be made.

The observing application 335 may further include a communication functionality with the agent device being observed. For example, should a change be determined to be required by the agent, the supervisor may transmit a message to the agent device indicating an improvement or change that may be made while performing the remainder of the video communication. The observing application 335 may additionally include an image review functionality. The image review functionality may be a manual way for the supervisor to approve or disapprove of the agent prior to performing a video communication. For example, the supervisor may contact the agent and request an image to be transmitted of a most likely visual area that will be viewed during the video communication. The image may be transmitted to the supervisor device 135 via the transceiver 325. The observing application 335 may show the image to the supervisor via the display device 315 for evaluation.

It should be noted that the manual inspection and review by the supervisor is only exemplary. As will be described in further detail, the preliminary steps of the supervisor observing the video communication or requesting the image prior to the agent participating in the video communication may be manually performed by the supervisor. However, the actual inspection and review may be performed in an automated manner such as through the monitoring device 140. That is, the monitoring device 140 or a further application of the supervisor device 135 may provide indications of the agent and visual area of whether they are in acceptable parameters.

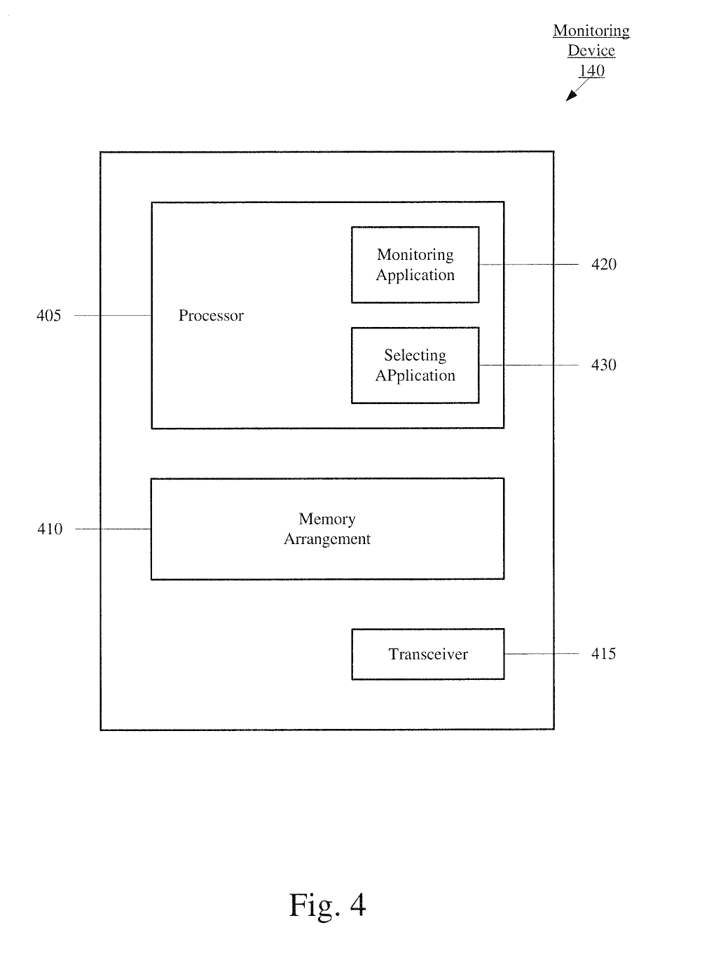

FIG. 4 shows the exemplary monitoring device 140 of the contact center system 100 of FIG. 1. As discussed above, the monitoring device 140 may be a mechanism that performs an automated inspection of agent actions during a video communication or of a visual area prior to an agent participating in a video communication. The monitoring device 140 may be configured to automatically determine these inspections and perform subsequent actions dependent upon the results of the inspections.

The monitoring device 140 may be preconfigured with a variety of parameters to perform the inspections. For example, an administrator or the supervisor may pre-program the monitoring device 140 to perform its intended functionality. In a substantially similar manner as the agent device 120 and the supervisor device 135, the monitoring device 140 may represent any electronic device that is configured to perform the functionalities described herein. The monitoring device 140 may include a processor 405, a memory arrangement 410, and a transceiver 415 that provide functionalities substantially similar to those corresponding to the agent device 120. It should be noted that the monitoring device 140 may also include further components such as a display device and an I/O device that enable the administrator to configure the monitoring device 140 to perform its intended functionalities. However, it should also be noted that the monitoring device 140 may be configured to receive these instructions via the transceiver 215 to automatically implement the policies upon reception.

The processor 405 may be configured to execute a monitoring application 420. The monitoring application 420 may receive the images captured via the imager 230 and processed by the capturing application 240. More specifically, the images may be provided such that a video may be reviewed by the monitoring application 420. That is, the monitoring application 420 may review the agent actions based upon an instantaneous standard or upon a time-lapse standard.

When related to an instantaneous standard, the monitoring application 420 may provide this functionality when evaluating a visual area prior to an agent participating in a video communication or an agent action during the video communication. For example, prior to participating in a video communication, an appearance of the agent may be reviewed from an image that is captured and received. The acceptable parameters may include a plurality of criteria such as a general overall appearance of the agent, a dress code, wearing of religious or political garments, visible jewelry/piercings/tattoos, visible background appearance, etc. Thus, through different tools such as a text analyzer, the presence of an unacceptable item may be identified. Although different contact centers may implement different rules regarding these criteria, the standards may be pre-programmed into the monitoring device 140 as discussed above. As such, the monitoring application 420 may determine whether any of these items are visible in the image that represents a visual area viewable by a user during the video communication. When present, the monitoring application 420 may transmit an indication to the selecting application 430 regarding an identity of the agent and/or the agent device being used.

The selecting application 430 may be configured to select the agent device being indicated by the monitoring application 420 and perform subsequent actions. For example, the indication may state that the unacceptable parameter may be easily addressed. Accordingly, the selecting application 430 and/or the monitoring application 420 may determine the change and transmit a message to the agent instructing the change be performed. A subsequent evaluation may be performed and upon completing the requested change, the agent and visual area may be within the acceptable parameters. When the agent and visual area are determined to be within the acceptable parameters, the monitoring application 420, the selecting application 430, and/or the supervisor may allow the agent to participate in video communications.

The monitoring application 420 may further perform the evaluation of agent actions during the video communication. For example, the monitoring application 420 may be configured with a variety of sensing applications to detect expressions, emotions, gestures, etc. that the agent is doing while on the video communication. Thus, through different tools, a determination of whether the actions of the agent are acceptable item may be performed. Again, different contact centers may implement different rules regarding these criteria and they may be pre-programmed into the monitoring device 140 as discussed above. As such, the monitoring application 420 may determine whether any of these items are present in the video. When present, the monitoring application 420 may transmit an indication to the selecting application 430 regarding an identity of the agent and/or the agent device being used to perform subsequent actions in a substantially similar manner discussed above.

As discussed above, the supervisor device 135 may also receive the images (for evaluation prior to agent participation in the video communication) and/or video (for evaluation during the video communication). The monitoring device 140 may perform the above described functionalities in a substantially similar manner and provide feedback to the supervisor. The feedback may include recommendations of changes that may be required for the agent to complete. The supervisor may therefore perform the subsequent actions in a manual manner.

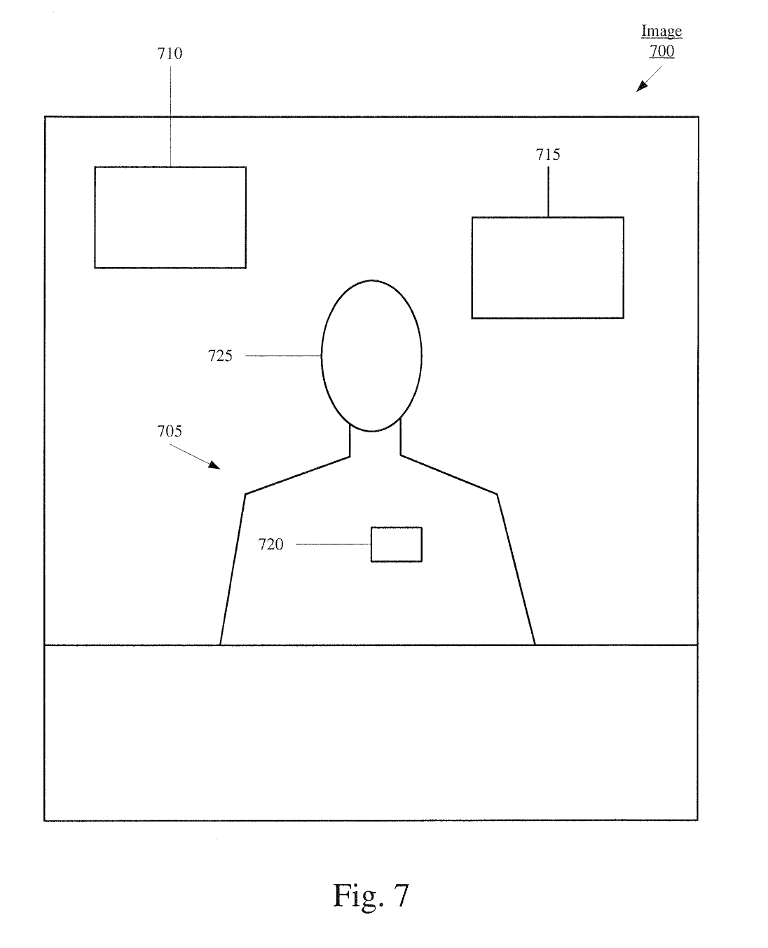

In a particular example, FIG. 7 shows an image 700 of a visual area in a video communication. Within the image 700, the agent 705 may be seen. Within the visual area, a background may include background objects such as objects 710, 715. The agent 705 may also be wearing clothing including an object 720. Furthermore, the facial expression 725 of the agent 705 may be seen. With the possibility of working remotely and with personal decorations being possibly present, the visual area may include these types of items that may be outside the acceptable parameters of visual requirements in video communication for the contact center.

When evaluating agent actions, the monitoring application 420 may optimize supervisor time in monitoring the video communications by providing historical recordings or conferenced into ongoing video communications likely to contain materials or items outside the acceptable parameters such as those damaging to a corporate brand associated with the contact center. That is, the monitoring application 420 may identify the video communications in a contact center that should be monitored for quality assurance purposes based on verbal and non-verbal communications included therein. The items in this respect may be the facial expression 725 that may be done by the agent during the video communication.

In a first example, the monitoring application 420 may include an emotion checker for both the agent and user. If facial expressions of anger, frowning, frustration, etc. and frequencies thereof are identified for real-time or historical quality monitoring, the monitoring application 420 may provide an indication to the selecting application 430 for these video communications including an identity of the agent and agent device. In a second example, the monitoring application 420 may include an expression checker for whether the agent is smiling while conversing with the user and/or gauging a smiling reaction from the user. When the monitoring application 420 identifies that the agent is not smiling enough, the selecting application 430 may be provided the indication and a possible subsequent action may entail transmitting a message to the agent to attempt to rectify a current facial expression during a remainder of the video communication. In a third example, the monitoring application 420 may include a gesture checker for whether the agent or user is performing a particular gesture that is indicative of a corresponding emotion or response. When the monitoring application 420 identifies that the agent is performing an inappropriate hand gesture, the selecting application 430 may be provided the indication and a possible subsequent action may entail transmitting a message to the agent to cease performing the inappropriate hand gesture. When the monitoring application 420 identifies that the agent is gesticulating too much, the selecting application 430 may be provided the indication and a possible subsequent action may entail transmitting a message to the agent to decrease the gesticulation.

Accordingly, the monitoring application 420 may subscribe to the video communications in progress and review the embellishments attributed to it by available facial and gesture recognition applications. Certain criteria may be applied to escalate for supervisor attention in either real-time or on a historical basis for video communications where the agent behavior is outside the acceptable parameters. That is, the exemplary embodiments may further combine the automated approach as well as the manual approach should a need rise.

When evaluating the visual area, the monitoring application 420 may also optimize supervisor time in determining whether an agent is approved to participate in video communications such as from displaying or wearing items that are outside the acceptable parameters that may damage a corporate brand associated with the contact center. That is, the monitoring application 420 may identify the agents who should be restricted to voice communications only or allowed to participate in either voice or video communications. The items in this respect may be the background items such as objects 710, 715 or worn items such as object 720. For example, the objects 710, 715 may be posters or pictures while the object 720 may be a name tag or image.

In a first example, the monitoring application 420 may include an optical recognition application that identifies from the image 700 if any text in the visual area includes messages that are of political, religious, offensive, competitive, etc. nature. These appearances may normally not be permitted if involved in a video communication with a user. For example, if wearing a uniform, the object 720 may be a nametag. However, if working remotely and outside of uniform, the object 720 may include an offensive statement. In a second example, the monitoring application 420 may include a visual inspection application to identify an appearance of the agent such as wardrobe, visibility of piercings, hairstyling, tattoos, etc. If outside the acceptable parameters, the monitoring application 420 may identify the agent for approval/disapproval in video communications. For example, the agent 705 may have display body art that may be offensive to an average user who contacts the contact center.

Accordingly, the monitoring application 420 may provide an initial mechanism for agent and visual area review prior to enabling or disabling the ticket application 235 from performing video communications with users. In a substantially similar manner as the agent actions, certain criteria may be applied to escalate for supervisor attention in either real-time or on a historical basis for video communications where the image 700 is outside the acceptable parameters. That is, the exemplary embodiments may further combine the automated approach as well as the manual approach should a need rise.

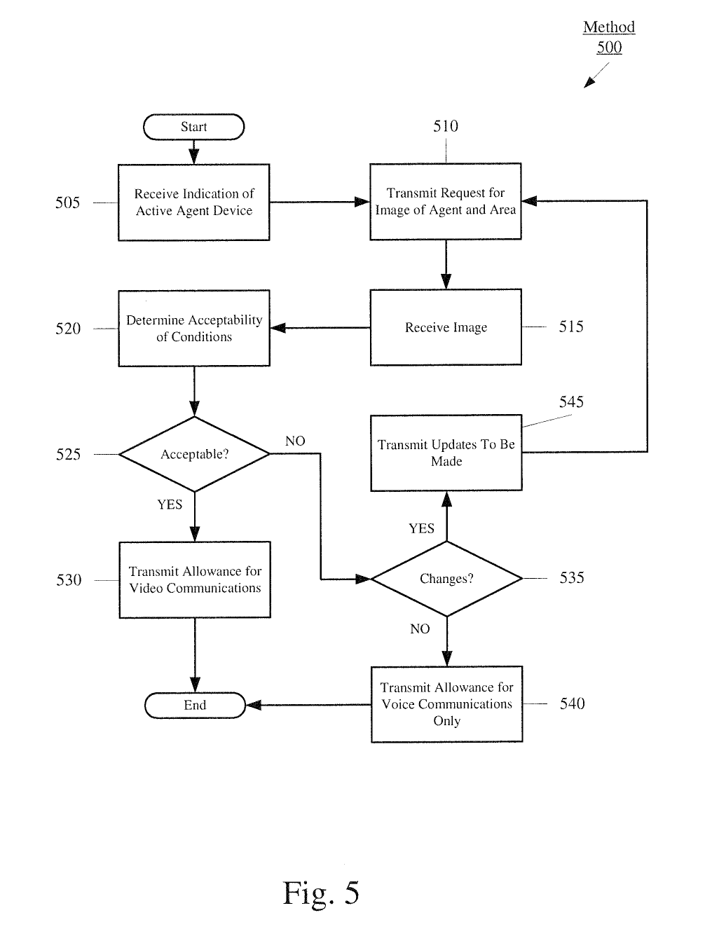

FIG. 5 shows an exemplary method 500 for determining visual components of a visual area in a video communication. The method 500 may relate particularly to evaluating the image 700 to determine whether the agent 705 is allowed to participate in video communications based upon objects that may be present within the visual area. The method 500 will be described with regard to the contact center system 100 of FIG. 1, the agent device 120 of FIG. 2, the supervisor device 135 of FIG. 3, the monitoring device 140 of FIG. 4, and the image 700 of FIG. 7.

In step 505, the monitoring application 140 receives an indication of an active agent device 120-130. For example, the agent may log into the contact center network 115 using one of the agent devices 120-130. Upon being activated, the monitoring device 140 may perform this initial evaluation of the agent to determine permissions for the time the agent is working. In step 510, the monitoring device 140 transmits a request for the image 700 of the agent 705 including the facial expression 725 and the visual area that may include objects 710-720. In step 515, the monitoring device 140 receives the image 700.

In step 520, the monitoring device 140 determines an acceptability of the conditions of the image 700 including what is viewed on the agent and the visual area. As discussed above, the visual area may include a variety of objects that may be outside the acceptable parameters and/or the agent may appear outside the acceptable parameters. In step 525, the monitoring device 140 determines whether the image 700 is within the acceptable parameters. That is, this indirectly determines whether the agent and the surrounding area is within acceptable parameters for video communications. If acceptable, the monitoring device 140 continues the method 500 to step 530 where the allowance indication for video communications is transmitted to the agent device.

However, if unacceptable, the monitoring device 140 continues the method 500 to step 535. In step 535, the monitoring device 140 may determine potential changes that may be made to bring the image 700 into the acceptable parameters. For example, the object 710 may be an offensive poster. The potential change may simply be to take the poster down. In another example, agent may have features such as tattoos that cannot be covered up and permanently be shown. The monitoring device 140 may determine that no change may be performed for this. Thus, if a change is determined to not be possible and the image 700 remains outside the acceptable parameters, the monitoring device 140 continues the method 500 to step 540 where the allowance indication for voice communications only is transmitted to the agent device.

However, if changes are determined, the monitoring device 140 continues the method 500 to step 545. In step 545, the monitoring device 140 may transmit the updates or changes to be made by the agent to bring the image 700 into acceptable parameters. Subsequently, the monitoring device 140 returns the method 500 to step 510 where a further request is transmitted for an image of the agent and the visual area for a further evaluation. If the changes are properly performed, the image 700 has an increased probability of being within the acceptable parameters to enable the agent to perform video communications.

It should be noted that the steps of the method 500 described above are only exemplary. That is, the method 500 may have additional, less, or modified steps. For example, upon the agent device being activated, the agent device may be configured to capture an image and automatically transmit the image to the monitoring device 140. In another example, the supervisor using the supervisor device 135 may provide an overriding indication from the determinations made by the monitoring device 140.

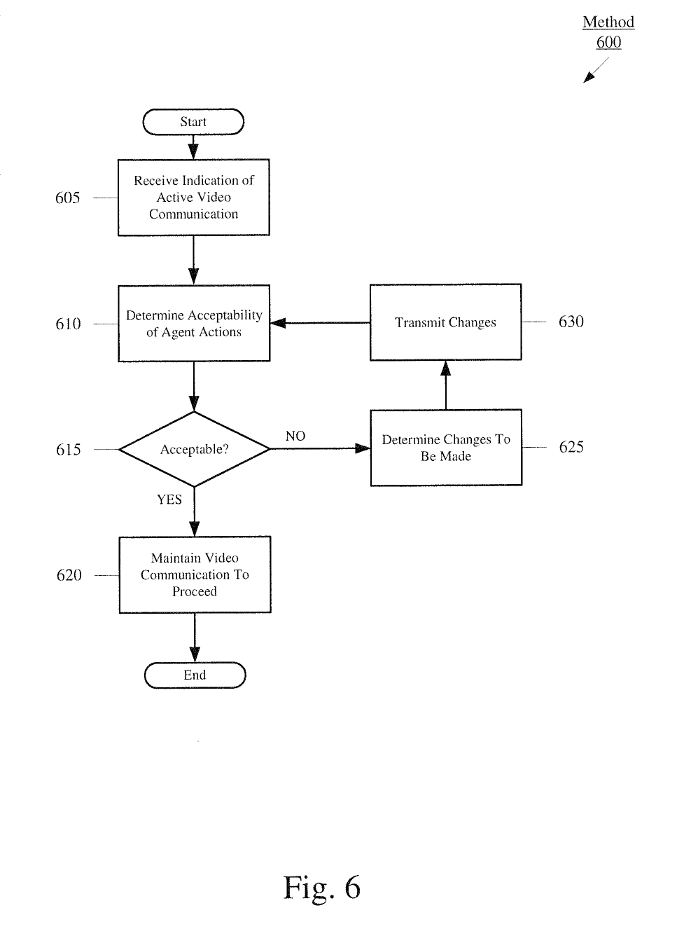

FIG. 6 shows an exemplary method 600 for determining agent actions during a video communication. The method 600 may relate particularly to evaluating the expressions, emotions, and gestures of the agent but may also relate to evaluating these aspects of the user. The method 600 also assumes that the agent has been approved for video communications using, for example, the above method 500 or from supervisor intervention. The method 600 will be described with regard to the contact center system 100 of FIG. 1, the agent device 120 of FIG. 2, the supervisor device 135 of FIG. 3, the monitoring device 140 of FIG. 4, and the image 700 of FIG. 7.

In step 605, the monitoring device 140 receives an indication of an active video communication. Specifically, the agent devices 120-130 may be configured to transmit this indication automatically to the monitoring device 140 when a request has been forwarded to the agent device that initiates the video communication with the user of the user device 105. in step 610, the monitoring device 140 may determine an acceptability of agent actions using the sensing tools discussed above.

In step 615, the monitoring device 140 determines whether the agent actions are within acceptable parameters. For example, a determination may be made as to whether the agent is smiling sufficiently or whether particular gestures are being made. If within acceptable parameters, the monitoring device 140 continues the method 600 to step 620 where the video communication is maintained to proceed. However, it should be noted that the monitoring device 140 may return the method 600 to step 610 for continued monitoring until the video communication is concluded.

However, if the outside the acceptable parameters, the monitoring device 140 continues the method 600 to step 625. In step 625, the monitoring device 140 determines any changes to be made in a substantially similar operation as that discussed above with regard to step 535 of the method 500. If changes are determined, the changes are transmitted to the agent device. Subsequently, the monitoring device 140 returns the method 600 to step 610 for continued monitoring until a predetermined time or until the video communication is concluded.

It should be noted that the steps of the method 600 described above are only exemplary. That is, the method 600 may have additional, less, or modified steps. For example, the acceptability of the user actions may also be evaluated. Specifically, the user actions may indicate a response to the agent actions although the agent actions are within acceptable parameters. In another example, the changes to be made may include further operations. Specifically, if the agent actions are beyond a predetermined measure outside the acceptable parameters, an indication may be transmitted to the supervisor for supervisor intervention. If a determination is made that the brand will be irrevocably harmed, an exemplary action may include terminating the video communication. In a third example, the supervisor may provide manual inputs of changes that may be forwarded to the agent device.

The exemplary embodiments provide a system and method of quality monitoring and agent suitability in video communications processed in a contact center. When a user established a connection with a contact center and is placed into a video communication to address a request, the user has access to view the agent and a visual area around the agent. To monitor the quality of this video communication, the exemplary embodiments provide a first mechanism to ensure that the agent and the visual area that is shown is within acceptable parameters. The exemplary embodiments provide a second mechanism to ensure that the agent actions and the user reactions are within acceptable parameters during the video communication.

Those skilled in the art will understand that the above-described exemplary embodiments may be implemented in any suitable software or hardware configuration or combination thereof. An exemplary hardware platform for implementing the exemplary embodiments may include, for example, an Intel ×86 based platform with compatible operating system, a Mac platform and MAC OS, a mobile device having an operating system such as iOS, Android, etc. In a further example, the exemplary embodiments of the above described method may be embodied as a program containing lines of code stored on a non-transitory computer readable storage medium that, when compiled, may be executed on a processor or microprocessor.

It will be apparent to those skilled in the art that various modifications may be made in the present invention, without departing from the spirit or the scope of the invention. Thus, it is intended that the present invention cover modifications and variations of this invention provided they come within the scope of the appended claims and their equivalent.

1. A method, comprising:
receiving, by a monitoring device, a plurality of consecutive images of a video communication between an agent device used by an agent of a contact center and a user device used by a user with a request;
determining, by the monitoring device, at least one agent action performed during the video communication that is outside a predetermined parameter;
determining, by the monitoring device, a change that the agent is to perform in the video communication based upon the agent action;
determining, by the monitoring device, the agent action is outside the predetermined parameter by at least an escalation parameter;
transmitting, by the monitoring device, the change to the agent device; and
transmitting, by the monitoring device, an indication to a supervisor device of the contact center, the indication including an identity of the agent.

2. The method of claim 1, wherein the agent action includes one of a facial expression, an emotion, and a gesture.

3. The method of claim 1, further comprising:
determining, by the monitoring device, at least one user action performed during the video communication, the user action being indicative of a response to the at least one agent action.

4. The method of claim 3, further comprising:
determining, by the monitoring device, a further change that the agent is to perform based upon the user action.

5. The method of claim 1, further comprising:
performing, by the monitoring device, an initial check of the agent and a visual area shown during the video communication.

6. The method of claim 5, wherein the initial check further comprises:
receiving, by the monitoring device, an image including the agent and the visual area; and
determining, by the monitoring device, at least one object shown in the image that is outside a further predetermined parameter.

7. The method of claim 6, further comprising:
determining, by the monitoring device, a further change that the agent is to perform based upon the at least one object; and
transmitting, by the monitoring device, the change to the agent device.

8. The method of claim 5, further comprising:
transmitting, by the monitoring device, an allowance indication for the agent device to perform the video communication.

9. The method of claim 6, further comprising:
transmitting, by the monitoring device, a denial indication for the agent device to perform the video communication.

10. The method of claim 9, wherein the denial indication disables a video communication functionality of the agent device and enables a voice communication functionality of the agent device.

11. A monitoring device, comprising:
a transceiver configured to receive a plurality of consecutive images of a video communication between an agent device used by an agent of a contact center and a user device used by a user with a request; and
a processor configured to determine at least one agent action performed during the video communication that is outside a predetermined parameter, the processor configured to determine a change that the agent is to perform in the video communication based upon the agent action, the processor configured to determine the agent action is outside the predetermined parameter by at least an escalation parameter,
wherein the transceiver is further configured to transmit the change to the agent device,
wherein the transceiver is further configured to transmit an indication to a supervisor device of the contact center, the indication including an identity of the agent.

12. The monitoring device of claim 11, wherein the agent action includes one of a facial expression, an emotion, and a gesture.

13. The monitoring device of claim 11, wherein the processor is further configured to determine at least one user action performed during the video communication, the user action being indicative of a response to the at least one agent action.

14. The monitoring device of claim 13, wherein the processor is further configured to determine a further change that the agent is to perform based upon the user action.

15. The monitoring device of claim 11, wherein the processor is further configured to perform an initial check of the agent and a visual area shown during the video communication.

16. The monitoring device of claim 15, wherein the processor is further configured to perform the initial check by:
receiving, by the monitoring device, an image including the agent and the visual area; and
determining, by the monitoring device, at least one object shown in the image that is outside a further predetermined parameter.

17. The monitoring device of claim 16, wherein the processor is further configured to determine a further change that the agent is to perform based upon the at least one object and transmit the change to the agent device.

18. The monitoring device of claim 15, wherein the processor is further configured to transmit an allowance indication for the agent device to perform the video communication.

19. The monitoring device of claim 16, wherein the processor is further configured to transmit a denial indication for the agent device to perform the video communication.

20. A method, comprising:
receiving, by a monitoring device, an image including an agent using an agent device of a contact center and a visual area surrounding the agent, the visual area defining boundaries for a viewable area in a video communication;
determining, by the monitoring device, at least one object shown in the image that is outside a predetermined parameter;
transmitting, by the monitoring device, an allowance indication for the agent device to perform the video communication when a change is determined for the at least one object, the change placing the at least one object within the predetermined parameter; and
transmitting, by the monitoring device, a denial indication for the agent device to perform the video communication when the at least one object remains outside the predetermined parameter.
